(19) United States
(12) Patent Application Publication
(10) Pub. No.: US 2003/0057204 A1
(43) Pub. Date: Mar. 27, 2003

(54) Microwave continuous heating equipment with workpiece transport path having meandering shape

(76) Inventors: Tomio Minobe, Fujimi-city (JP); Kouji Mikami, Iruma-gun (JP); Satoru Yamaguchi, Anjo-city (JP); Hitoshi Kanmura, Inabe-gun (JP); Hiromi Katou, Kuwana-city (JP); Yasunao Miura, Nagoya-city (JP)

Correspondence Address: NIXON VANDERHYE P.C., 8th Floor, 1100 North Glebe Road, Arlington, VA, 22201, US

(21) Appl. No.: 10/254,018

(22) Filed: Sep. 25, 2002

(30) Foreign Application Priority Data
Sep. 26, 2001 (JP) 2001-294764

(51) Int. Cl. H05B 6/78; F27D 11/00

(52) U.S. Cl. 219/699; 219/388

(57) ABSTRACT

The invention provides microwave continuous heating equipment that does not need redesigning even when workpiece size or length is changed, and that can perform efficient heat treatment by continuously radiating microwave power while preventing leakage of the microwave power. The microwave continuous heating equipment comprises a heating chamber 11, microwave absorbing chambers 13 and 14 connected to the front and rear ends, respectively, of the heating chamber, and transport equipment 15 for transporting workpieces thereon through the front-end microwave absorbing chamber 13, the heating chamber 11, and the rear-end microwave absorbing chamber 14 in the order state. Each of the microwave absorbing chambers 13 and 14 includes a workpiece transport path 13a, 14a having a meandering shape to prevent the microwave power from passing straight through an opening 13b, 14b at one end and an opening 13c, 14c, at the other end.

### BACKGROUND OF THE INVENTION

1. Field of the Invention

The present invention relates to microwave continuous heating equipment which heat-treats a workpiece in a heating chamber by radiating microwave power onto the workpiece while the workpiece is passing through the heating chamber and, more particularly, to a microwave leakage preventing structure, of a simple configuration, that can prevent leakage of microwave power without requiring cutting off microwave power radiation when a workpiece is transported into or out of the heating chamber.

2. Description of the Related Art

Generally, a heating chamber in microwave continuous heating equipment has an opening through which a workpiece is charged and an opening through which workpiece is discharged, and various means have been devised to prevent microwave power from leaking out through the openings.

The most common method employed to prevent microwave power from leaking to the outside is to install a microwave absorbing type filter on each opening.

This type of leakage preventing structure is fabricated by making a filter cover from a metal material having a microwave power reflecting property, and by covering its interior side (the side on which microwaves are present and the workpiece is passed therethrough) with a tile made of a material that absorbs microwave power extremely well (for example, carbon, ferrite, or silicon carbide), or by forming a microwave absorbing zone (absorbing chamber) by filling a liquid having a large microwave absorbing power into a tube or container made of a material, such as Teflon, polyethylene, or polypropylene, having a small microwave absorbing power, thereby preventing the microwave power from leaking to the outside.

However, for this type of microwave filter to function effectively, it is required that its opening size be smaller than one wavelength of the microwave power.

For example, when the frequency of the microwave power used is 2450 MHz, since one wavelength is about 120 mm, it is desirable that the filter's opening size be not larger than a half wavelength (60 mm).

Accordingly, when there is a need to feed a large workpiece therethrough that requires an opening equal to or larger than one wavelength of the microwave power used, if leakage of the microwave power is to be prevented by the microwave filter, the length of the microwave filter must be made very long, but in many cases, this is difficult to achieve because of limited installation space or from the standpoint of productivity, etc.

To solve the above problem, microwave continuous heating equipment has already been developed that has, instead of a microwave filter, a microwave power shielding shutter that can be opened and closed on each opening of the heating chamber.

In this continuous heating equipment, a front auxiliary chamber and a rear auxiliary chamber are provided at the front and rear of the heating chamber, respectively, and a metal shutter is installed at the opening formed in a partition wall of each auxiliary chamber.

More specifically, two shutters spaced apart one behind the other are provided at the entrance side of the heating chamber, and as many shutters at the exit side of the heating chamber; these shutters are individually opened in a controlled manner as the workpiece, being carried on transport equipment, approaches the respective shutters during the transport process in which the workpiece charged into the front auxiliary chamber is transported through the heating chamber and discharged from the rear auxiliary chamber.

In this process, the two shutters at each of the entrance and exit sides operate in such a manner that one shutter is opened while the other is closed, to prevent the microwave power from leaking to the outside.

This allows the microwave power to be radiated continuously without interruption.

In the continuous heating equipment having two shutters at each of the front and rear openings of the heating chamber as described above, a workpiece can be heat-treated as long as its size is smaller than that of the front and rear openings of the heating chamber, and this offers the advantage of greater versatility compared with continuous heating equipment of the type that uses a microwave filter.

However, the above-described continuous heating equipment equipped with shutters at the openings has the following problem.

That is, this type of continuous heating equipment requires that the shutters be opened and closed in coordinating fashion with the workpiece flow, and also that the two shutters installed at each of the entrance and exit sides be operated in such a manner that one shutter is opened while the other is closed.

This means that the same spacing (transport pitch) must always be provided between workpieces being transported, and that the spacing must be made larger than the size of at least a workpiece.

There is also the constraint that the dimension of each workpiece in the transport direction must be made the same.

However, if the transport pitch or spacing between the workpieces is large, the microwave heating efficiency in the heating chamber, and hence the equipment efficiency, drops; on the other hand, if the length of the heating chamber is increased to increase the microwave heating efficiency, there arises the problem that the overall equipment size increases.

Furthermore, as the equipment structure is determined by the workpiece dimension in the transport direction, i.e., the transport pitch, if the workpiece dimension in the transport direction is greater than the predetermined length, separate heating equipment, that matches the workpiece length, would become necessary; on the other hand, if the workpiece dimension in the transport direction is smaller than the predetermined length, the spacing between the workpieces further increases, decreasing the equipment efficiency.

To enable workpieces to be transported at reduced pitch in a two-shutter configuration, the Applicant has previously proposed a method that moves one of the two shutters in reciprocating fashion along the workpiece transport direction (see Japanese Unexamined Patent Publication (Kokai) No. 8-264276).

This method, however, has the disadvantage that not only the construction but also operation control for the two shutters becomes complex, as one of the shutters needs to be moved in reciprocating fashion along the workpiece transport direction.

Moreover, the above method has a problem in terms of versatility, as the stroke of the shutter's reciprocating motion, the operating timing for the shutters, etc. must be adjusted according to workpiece length, transport pitch, etc.

### SUMMARY OF THE INVENTION

In view of the above situation, it is an object of the present invention to provide microwave continuous heating equipment that does not need redesigning even when workpiece size or length is changed, and that can heat-treat workpieces by transporting them at such a feed pitch that provides hardly any spacing between them, and can perform efficient heat treatment by continuously radiating microwave power while reliably preventing leakage of the microwave power.

To achieve the above object, the present invention proposes microwave continuous heating equipment comprising a heating chamber, microwave absorbing chambers connected to the front and rear ends, respectively, of the heating chamber, and transport equipment for transporting workpieces thereon through the front-end microwave absorbing chamber, the heating chamber, and the rear-end microwave absorbing chamber in the order state, wherein the microwave continuous heating equipment performs heat treatment by radiating microwave power onto the workpieces being transported through the heating chamber, and wherein each of the microwave absorbing chambers includes a workpiece transport path having a meandering shape to prevent the microwave power from passing straight through the openings at both ends thereof.

In the microwave continuous heating equipment having the above configuration, as the microwave absorbing chambers connected to the front and rear ends of the heating chamber respectively include the workpiece transport paths, and as each workpiece transport path is formed in a meandering shape so as to prevent microwave power from passing straight through the openings at both ends thereof, the microwave power leaking from the heating chamber into the workpiece transport path in the microwave absorbing chamber is reflected, absorbed inside the microwave absorbing chamber, and prevented from leaking outside.

Accordingly, even when the size of a workpiece is larger than one wavelength of the microwave power used in the heating chamber, the microwave power can be effectively absorbed and caused to disappear in the microwave absorbing chambers through which the workpiece is transported, and can thus be prevented from leaking to the outside.

As a result, there is no need to turn on and off the microwave power radiation during operation, and thus the workpiece can be efficiently heat-treated by continuously radiating the microwave power.

Furthermore, even when transporting workpieces at such a feed pitch that minimizes the spacing between them, as the workpieces can be transported while preventing the leakage of the microwave power in the microwave absorbing chambers, and allowing the microwave power to be radiated continuously, the length of the heating chamber, as well as the length of each of the microwave absorbing chambers provided at the front and rear ends thereof, can be held to a minimum, and the overall size of the equipment can thus be reduced.

In particular, as the wasteful space between workpieces can be minimized, a larger number of workpieces can be accommodated in the heating chamber, and the heating efficiency of the microwave power can be increased and the heat treatment cost reduced.

In the microwave continuous heating equipment having the above configuration, preferably, the workpiece transport path in each of the microwave absorbing chambers can be formed in a meandering shape substantially resembling the letter L, a crank shape, the letter U, or the letter S.

Further preferably, in the microwave continuous heating equipment having the above configuration, each of the microwave absorbing chambers can be a structure whose exterior side is covered with a metal cover, and whose interior side is covered with a microwave absorbing material having good microwave absorbance.

Further, in the microwave continuous heating equipment having the above configuration, metal shutters may be installed at front and rear openings, respectively, of the heating chamber.

Further, the microwave continuous heating equipment described above may be configured as drying equipment for drying a ceramic molding, as a workpiece, by heating.

The present invention may be more fully understood from the description of the preferred embodiments of the invention set forth below, together with the accompanying drawings.

### BRIEF DESCRIPTION OF THE DRAWINGS

In the drawings:

FIG. 1 is a longitudinal vertical cross-sectional view schematically showing microwave continuous heating equipment according to a first embodiment of the present invention;

FIG. 2 is a cross-sectional view, taken along line II-II in FIG. 1, showing the interior of a microwave absorbing chamber at the exit side of the continuous heating equipment shown in FIG. 1;

FIG. 3A is a horizontal cross-sectional view showing in schematic form the interior of the microwave absorbing chamber provided at the entrance side of the continuous heating equipment shown in FIG. 1;

FIG. 3B is a horizontal cross-sectional view showing in schematic from the interior of the microwave absorbing chamber provided at the exit side of the continuous heating equipment shown in FIG. 1;

FIG. 4 is a longitudinal vertical cross-sectional view schematically showing microwave continuous heating equipment according to a second embodiment of the present invention;

FIG. 5A is a perspective view of a ceramic honeycomb structure; and

FIG. 5B is an enlarged plan view showing a portion of the honeycomb structure.

### DESCRIPTION OF THE PREFERRED EMBODIMENTS

The embodiments of the present invention will be described below with reference to the accompanying drawings.

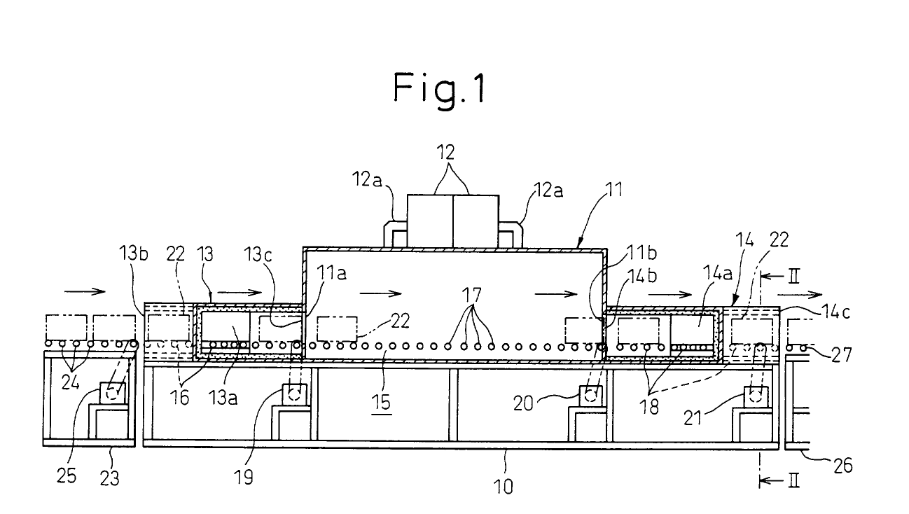

FIGS. 1 to FIGS. 3A and 3B are diagrams showing a first embodiment of the present invention.

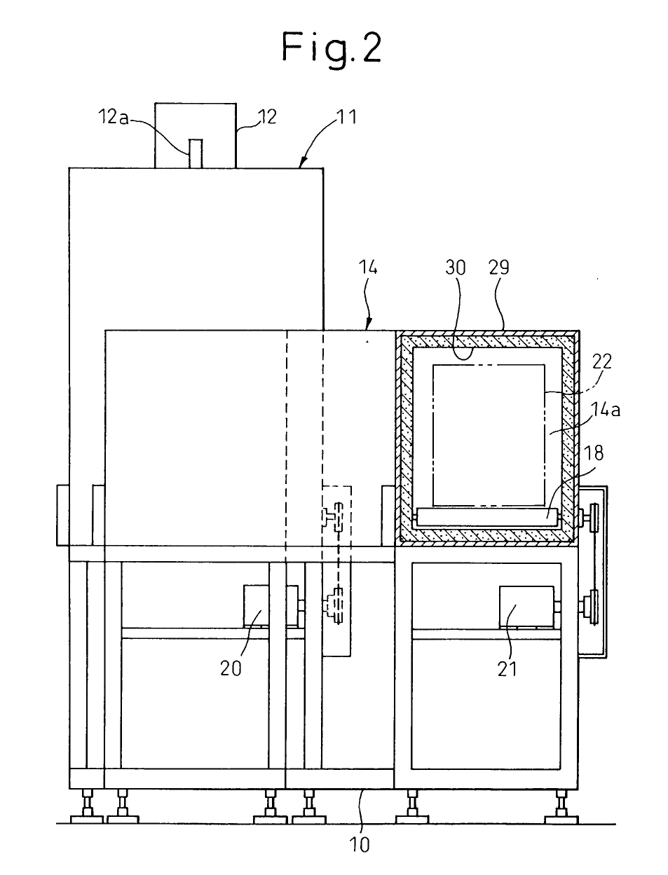

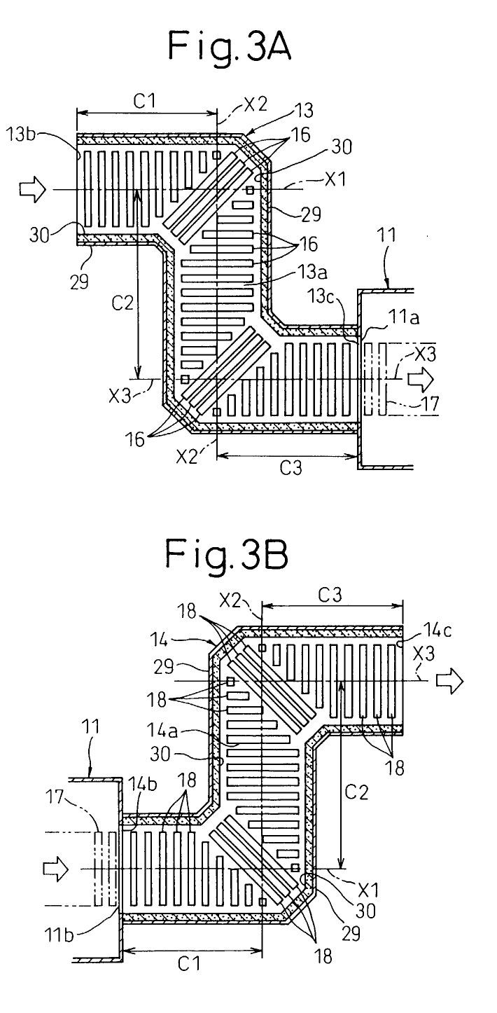

FIG. 1 is a longitudinal vertical cross-sectional view schematically showing microwave continuous heating equipment, FIG. 2 is a cross-sectional view, taken along line II-II in FIG. 1, showing the interior of a microwave absorbing chamber at the rear end, that is, at the exit side of the continuous heating equipment shown in FIG. 1, and FIGS. 3A and 3B are horizontal cross-sectional views respectively showing in schematic form the interior of the microwave absorbing chambers provided at the front and rear ends of the continuous heating equipment shown in FIG. 1.

As shown in FIG. 1, the microwave continuous heating equipment has a heating chamber 11 with openings 11a and 11b formed at the front and rear, that is, at the entrance and exit sides, respectively, and a plurality of microwave oscillators 12 are mounted on the top of the heating chamber 11, each microwave oscillator 12 being configured to transmit microwave power into the heating chamber 11 through a waveguide 12a.

Microwave absorbing chambers 13 and 14 respectively containing workpiece transport paths 13a and 14a therein are connected to the front and rear ends of the heating chamber 11, and are mounted on a base frame 10.

The workpiece transport path 13a in the microwave absorbing chamber 13 located at the front end, i.e., the entrance side of the heating chamber 11 has an entrance opening 13b opened to the outside and an exit opening 13c connected to the entrance opening 11a of the heating chamber 11.

On the other hand, the workpiece transport path 14a in the microwave absorbing chamber 14 located at the rear end, i.e., the exit side of the heating chamber 11 has an entrance opening 14b connected to the exit opening 11b of the heating chamber 11 and an exit opening 14c opened to the outside.

Transport equipment generally indicated by reference numeral 15 is of a roller conveyor type, and comprises a plurality of transport rollers 16 arranged inside the entrance-side microwave absorbing chamber 13, a plurality of transport rollers 17 arranged inside the heating chamber 11, a plurality of transport rollers 18 arranged inside the exit-side microwave absorbing chamber 14, and drive motors 19, 20, and 21 for driving the respective rollers 16, 17, and 18 which are driven to rotate, in an interlinked fashion, at the same speed.

The transport rollers 16 in the entrance-side microwave absorbing chamber 13 are driven for rotation in an interlinked fashion by the drive motor 19, while the transport rollers 17 in the heating chamber 11 and the transport rollers 18 in the exit-side microwave absorbing chamber 14 are respectively driven for rotation in an interlinked fashion by the respective drive motors 20 and 21.

The transport equipment 15 having the above-described configuration can thus transport workpieces 22 smoothly at constant speed along the entire transport path from the entrance opening 13b of the entrance-side microwave absorbing chamber 13 to the exit opening 14c of the exit-side microwave absorbing chamber 14.

While the workpiece 22 is being passed through the heating chamber 11, heat treatment can be applied to the workpiece 22 by radiating microwave power.

Further, a charge table 23 is placed adjacent to the entrance opening 13b of the microwave absorbing chamber 13 located at the entrance side of the heating chamber 11, and this charge table 23 is also provided with transport rollers 24 and a drive motor 25 so that a workpiece 22 placed on the transport rollers 24 can be charged into the microwave absorbing chamber 13.

On the other hand, a discharge table 26 is placed adjacent to the exit opening 14c of the microwave absorbing chamber 14 located at the exit side of the heating chamber 11, and this discharge table 26 is also provided with transport rollers 27 which are driven for rotation by a drive motor (not shown) so that the workpiece 22 fed out of the exit-side microwave absorbing chamber 14 can be received on the transport rollers 27 for transfer.

Here, it is desirable that the transport rollers 16, 17, and 18 be coated with a material, such as Teflon, glass wool, or polyamide, that does not easily absorb microwave power.

Further, the transport equipment 15 need not necessarily be limited to the roller conveyor type, but a belt conveyor type, or a pusher type that pushes a workpiece at a constant pitch by means of an air cylinder or the like, may be employed.

As shown in FIGS. 2 and 3, the microwave absorbing chambers 13 and 14 are each enclosed by a metal outer cover 29 whose interior side is lined with a microwave absorbent 30 made of a material that absorbs microwave power extremely well, for example, carbon, ferrite, or silicon carbide.

Next, the construction of the workpiece transport paths 13a and 14a in the microwave absorbing chambers 13 and 14 will be described in detail below with reference to FIG. 3.

As shown in FIG. 3A, the workpiece transport path 13a in the entrance-side microwave absorbing chamber 13 is bent in the shape of a crank to prevent microwave power from passing straight through the entrance opening 13b and the exit opening 13c.

More specifically, the workpiece transport path 13a has a first section C1, a second section C2, and a third section C3.

The first section C1 extends from the entrance opening 13b toward the transport direction of the workpiece 22 along axis line X1, the second section C2 extends along axis line X2 at right angles to the axis line X1, and the third section C3 extends along axis line X3 at right angles to the axis line X2 and parallel to the axis line X1, and leads to the exit opening 13c.

The axis line X3 of the third section C3 coincides with the axis line of the transport path in the heating chamber 11.

The lengths of the first section C1, the second section C2, and the third section C3 are set so that any microwave power leaking from the heating chamber 11 into the workpiece transport path 13a through the exit opening 13c of the microwave absorbing chamber 13 will not pass straight through the workpiece transport path 13a and reach the entrance opening 13b.

Accordingly, the microwave power entering the workpiece transport path 13a through the exit opening 13c always strikes the microwave absorbent 30 covering the interior side of the microwave absorbing chamber 13, and is reflected, absorbed by the microwave absorbent 30, and prevented from leaking outside.

Further, in the entrance-side microwave absorbing chamber 13, the plurality of transport rollers 16 are arranged and driven for rotation in an interlinked fashion so that the workpiece 22 can be smoothly transported from the first section C1 of the workpiece transport path 13a to the third section C3 via the second section C2.

The mechanism for causing such transport rollers 16 arranged along a crank-shaped path to rotate in interlinking fashion is well known in the art, and therefore, will not be illustrated or described in detail here.

On the other hand, as shown in FIG. 3B, the workpiece transport path 14a in the exit-side microwave absorbing chamber 14, like the transport path in the entrance-side microwave absorbing chamber 13, is bent in the shape of a crank to prevent microwave power from passing straight through the entrance opening 14b and the exit opening 14c.

More specifically, the workpiece transport path 14a has a first section C1, a second section C2, and a third section C3.

The first section C1 extends from the entrance opening 14b toward the transport direction of the workpiece 22 along the axis line X1 which coincides with the axis line of the transport path in the heating chamber 11, the second section C2 extends along the axis line X2 at right angles to the axis line X1, and the third section C3 extends along the axis line X3 at right angles to the axis line X2 and parallel to the axis line X1, and leads to the exit opening 14c.

In this microwave absorbing chamber 14 also, the lengths of the first section C1, the second section C2, and the third section C3 of the workpiece transport path 14a are set so that any microwave power leaking from the heating chamber 11 into the workpiece transport path 14a through the entrance opening 14b of the microwave absorbing chamber 14 will not pass straight through the workpiece transport path 14a and reach the exit opening 14c.

Accordingly, the microwave power entering the workpiece transport path 14a through the entrance opening 14b always strikes the microwave absorbent 30 covering the interior side of the microwave absorbing chamber 14, and is reflected, absorbed by the microwave absorbent 30 and prevented from leaking outside.

Further, in this microwave absorbing chamber 14, the plurality of transport rollers 18 are arranged and driven for rotation in an interlinked fashion so that the workpiece 22 can be smoothly transported from the first section C1 of the workpiece transport path 14a to the third section C3 via the second section C2.

In the above embodiment, the first to third sections C1, C2, and C3 of each of the workpiece transport paths 13a and 14a are arranged in the same plane (horizontal plane), but a height difference may be provided between the first section C1 and the third section C3 with the second section C2 arranged to connect between them.

In the microwave continuous heating equipment of the first embodiment having the above configuration, as the microwave absorbing chambers 13 and 14 connected to the front and rear ends of the heating chamber 11, respectively, include the workpiece transport paths 13a and 14a, and as the workpiece transport paths 13a and 14a are each formed in a meandering shape so as to prevent microwave power from passing straight between one end opening 13b or 14b and the other end opening 13c or 14c, respectively, the microwave power leaking from the heating chamber 11 into the workpiece transport paths 13a and 14a in the microwave absorbing chambers 13 and 14 is reflected and absorbed in the microwave absorbing chambers 13 and 14, and is prevented from leaking outside.

Accordingly, even when the size of the workpiece 22 is larger than one wavelength of the microwave power used in the heating chamber 11, the microwave power can be effectively absorbed in the microwave absorbing chambers 13 and 14, through which the workpiece 22 is transported, and can be prevented from leaking outside.

As a result, there is no need to turn on and off the microwave power radiation during operation, and thus the workpiece 22 can be efficiently heat-treated by continuously radiating the microwave power.

Furthermore, even when transporting workpieces 22 at such a feed pitch that minimizes the spacing between the workpieces 22, as the workpieces 22 can be transported while preventing the leakage of the microwave power in the microwave absorbing chambers 13 and 14, thus allowing the microwave power to be radiated continuously, the length of the heating chamber 11, as well as the length of each of the microwave absorbing chambers 13 and 14 provided at the front and rear ends thereof, can be held to a minimum, and the overall size of the equipment can thus be reduced.

In particular, as the wasteful space between workpieces 22 can be minimized, a larger number of workpieces 22 can be accommodated in the heating chamber 11, and the heating efficiency of the microwave power can be increased and the heat treatment cost reduced.

Furthermore, in the continuous heating equipment of the first embodiment, as the workpiece transport paths 13a and 14a in the microwave absorbing chambers 13 and 14 are each bent in the shape of a crank, microwave power can be effectively absorbed in the microwave absorbing chambers 13 and 14 without excessively increasing the overall length of the workpiece transport paths 13a and 14a in the microwave absorbing chambers 13 and 14.

As a result, the microwave absorbing chambers 13 and 14 can be made more compact in construction.

Here, the workpiece transport paths 13a and 14a in the microwave absorbing chambers 13 and 14 need only be formed in a meandering shape so as to prevent microwave power from passing straight through the entrance opening and the exit opening, and this shape is not limited to the crank-like shape; for example, each transport path may be formed in a meandering shape substantially resembling the letter L, the letter C or U, or the letter S.

In an alternative configuration, one opening 13b, 14b and the other opening 13c, 14c of the microwave absorbing chamber 13, 14 may be arranged so as to lie on a common axis; in that case, the intermediate section of the workpiece transport path 13a, 14a should be bent in a meandering shape, for example, in a shape substantially resembling the letter C or the letter U.

Furthermore, in the continuous heating equipment of the first embodiment, as the exterior of each of the microwave absorbing chambers 13 and 14 is covered with the metal cover 29, and the interior is lined with the microwave absorbent 30 having good microwave absorbance, the microwave absorbing chambers 13 and 14, combined with the workpiece transport paths 13a and 14a having the above-described meandering shape, can reliably confine therein the microwave power leaking from the heating chamber 11 into the workpiece transport paths 13a and 14a, and the microwave power can be reflected, absorbed by the microwave absorbent 30, and prevented from leaking outside.

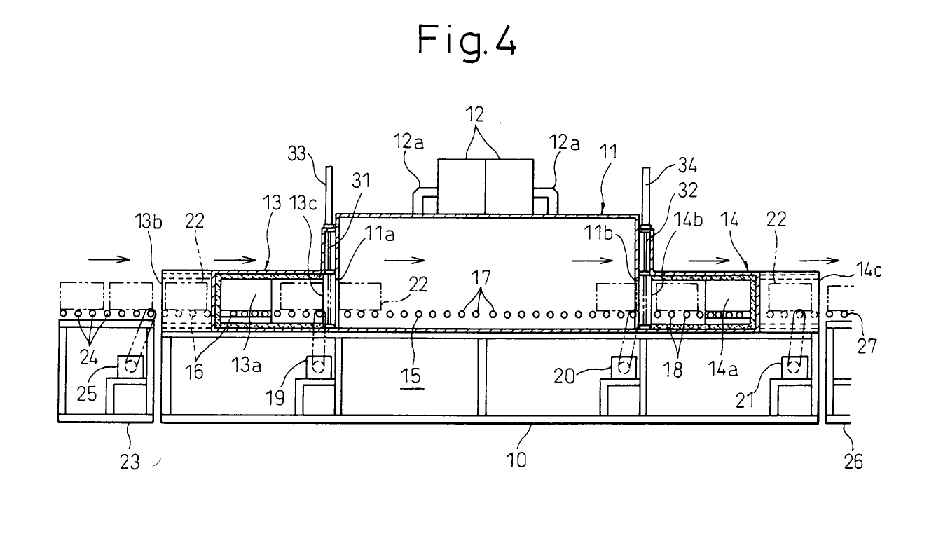

FIG. 4 is a longitudinal vertical cross-sectional view schematically showing microwave continuous heating equipment according to a second embodiment of the present invention. In the figure, constituent elements similar to those in the foregoing first embodiment are designated by the same reference numerals.

In the continuous heating equipment of the second embodiment, metal shutters 31 and 32 are installed at the front and rear openings 11a and 11b of the heating chamber 11.

The shutters 31 and 32 are opened and closed by being moved in vertical directions by air cylinders 33 and 34.

As in the foregoing first embodiment, in the continuous heating equipment of the second embodiment also, the workpiece transport paths 13a and 14a in the microwave absorbing chambers 13 and 14 have a crank-like meandering shape.

Accordingly, the microwave power leaking from the heating chamber 11 into the microwave absorbing chambers 13 and 14 can be reflected, absorbed in the microwave absorbing chambers 13 and 14, and can be prevented from leaking outside.

In particular, the continuous heating equipment of the second embodiment is configured so that when a plurality of workpieces 22 are fed in a line for heat treatment by the microwave power in the heating chamber 11, the metal shutters 31 and 32 installed at the front and rear openings 11a and 11b of the heating chamber 11 are respectively opened when the workpiece 22 at the head of the line approaches the respective shutters 31 and 32, and respectively closed when the workpiece 22 at the tail end of the line has passed the respective shutters 31 and 32; with this configuration, the amount of the microwave power leaking from the heating chamber 11 into the microwave absorbing chambers 13 and 14 at the front and rear of the heating chamber 11 can be held to a minimum.

That is, when the workpiece 22 at the head of the line enters the heating chamber 11, radiation of the microwave power can be started in the heating chamber 11, but at this time, the shutter 32 at the exit side of the heating chamber 11 is closed and, when the workpiece 22 at the head of the line approaches the shutter 32 after being heat-treated in the heating chamber 11, the shutter 32 can be opened; as a result, the microwave power in the heating chamber 11 is prevented from wastefully leaking into the exit-side microwave absorbing chamber 14 while the workpiece 22 at the head of the line is being heat-treated by the microwave power radiation in the heating chamber 11.

In this way, as wastage of the microwave power is prevented in the exit-side microwave absorbing chamber 14, heat treatment by the microwave power can be performed economically.

Furthermore, as the microwave absorbent 30 in the microwave absorbing chamber 14 can be prevented from being overheated, thermal degradation, damage, and other ill effects can be prevented, and thus the life of the microwave absorbent 30 can be extended.

On the other hand, when the workpiece 22 at the tail end of the line has passed the exit shutter 32, or when the radiation of the microwave power in the heating chamber 11 can be stopped; here, as the entrance shutter 31 can be closed when the workpiece 22 at the tail end of the line has passed the entrance shutter 31 and entered the heating chamber 11, the microwave power in the heating chamber 11 is prevented from wastfully leaking into the entrance-side microwave absorbing chamber 13 while the workpiece 22 at the tail end of the line is being heat-treated by the microwave power radiation in the heating chamber 11.

In this way, as wastage of the microwave power is prevented also in the entrance-side microwave absorbing chamber 13, heat treatment by the microwave power can be performed economically.

Furthermore, as the microwave absorbent 30 in the microwave absorbing chamber 13 can be prevented from being overheated, thermal degradation, damage, and other ill effects thereof can be prevented, and thus the life of the microwave absorbent 30 can be extended.

Here, it is desirable that the microwave oscillators 12 be controlled to start microwave oscillation after the entrance shutter 31 is opened, and that the microwave output energy be controlled in such a manner as to match the increase in the number of workpieces 22 fed into the heating chamber 11 and to reach its maximum when the maximum number of workpieces 22 are accommodated in the heating chamber 11.

Further, it is desirable that the microwave oscillators 12 be controlled to reduce the microwave output energy after the closure of the entrance shutter 31 in such a manner as to match the decrease in the number of workpieces 22 accommodated in the heating chamber 11, and to stop the microwave output when the workpiece 22 at the tail end of the line has passed the exit shutter 32.

In a specific example, the microwave continuous heating equipment described above can be implemented as drying equipment for drying a ceramic honeycomb structure, as a workpiece, by heating.

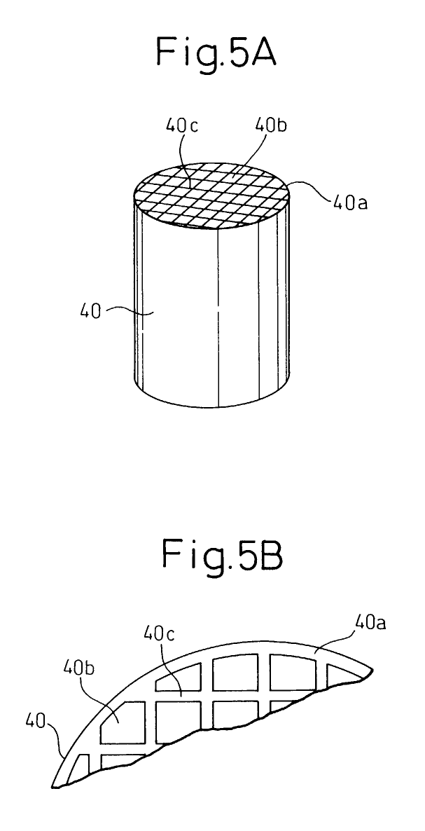

Ceramic honeycomb structures (ceramic moldings) are widely used for ceramic honeycomb catalyst carriers for automotive use, diesel particulate collecting ceramic filters, fuel cells, and other moldings; to produce such a ceramic honeycomb structure, a clay-like ceramic material with water, etc. added thereto is extruded through a die of an appropriate shape by a screw-type or piston-type extruder, thereby forming a cylindrical honeycomb structure containing numerous holes opened therein, as shown in FIGS. 5A and 5B.

Here, FIG. 5A is a perspective view of a ceramic honeycomb structure 40, and FIG. 5B is an enlarged plan view showing a portion of the honeycomb structure 40, in which reference numeral 40a, 40b and 40c indicate an outer skin portion, cells and a cell wall, respectively.

The ceramic honeycomb structure 40 produced by extrusion molding has a large volume on the order of 500 cm³ (cc) to 1500 cm³ (cc) and contains a large amount of moisture amounting to 10% to 30% of the total mass, and the cell wall 40c is extremely thin at 0.025 mm to 0.4 mm and thus lacks strength; as a result, if conventional hot air drying is used, there arises the problem that drying cracks may be caused due to localized dimensional differences that occur during drying shrinkage because of differences in drying speed between the exterior and interior portions.

If conventional microwave drying equipment is used for drying the ceramic structure, a batch dry method has to be used because of the volume and moisture content of the ceramic honeycomb structure 40, and microwave drying equipment equipped with a double shutter has to be used because of its large size.

This has resulted in continuous drying with long one-cycle time (tact time), including operation in which workpieces are synchronously transported, etc., and has greatly reduced productivity; on the other hand, as is apparent from the above description, when the microwave continuous heating equipment of the present invention is used, a workpiece such as the above-described ceramic structure 40 can also be dried continuously and efficiently.

The present invention has been described above with reference to the illustrated embodiments, but in an alternative embodiment, for example, the workpiece 22 may be placed on a jig and transported by the transport equipment 15. In that case, it is preferable to form all or part of the jig from a microwave transparent material.

As described above, according to the present invention, as the microwave absorbing chambers through which workpiece is passed are connected to the front and rear ends of the heating chamber, and as the workpiece transport path in each microwave absorbing chamber is formed in a meandering shape so as to prevent microwave power from passing straight through the openings at both ends thereof, the microwave power leaking from the heating chamber into the workpiece transport path in the microwave absorbing chamber can be reflected and absorbed, in a reliable manner, in the workpiece transport path, and can be prevented from leaking outside.

Accordingly, even when the size of the workpiece is larger than one wavelength of the microwave power used in the heating chamber, the microwave power can be effectively absorbed in the microwave absorbing chambers through which the workpiece is transported, and can thus be prevented from leaking outside.

As a result, there is no need to turn on and off the microwave power radiation during operation, and thus the workpiece can be efficiently heat-treated by continuously radiating the microwave power.

Furthermore, as the workpieces can be transported at a feed pitch with minimum workpiece spacing, the length of the heating chamber, as well as the length of each of the microwave absorbing chambers provided at the front and rear ends thereof, can be held to a minimum, making the installation space compact while enhancing heating efficiency and reducing the equipment cost.

On the other hand, according to the present invention in which the metal shutters are installed at the front and rear openings of the heating chamber, not only are the same effects as described above possible but, when starting the microwave power radiation in the heating chamber to heat-treat the workpieces being transported in a line and ending the microwave power radiation to stop the heat treatment, the respective shutters can be opened and closed in a controlled manner to prevent the microwave power in the heating chamber from wastfully leaking, during prescribed periods of time, into the front-end and rear-end microwave absorbing chambers, and thus heat treatment by the microwave power can be performed economically.

Furthermore, as the microwave absorbent in each absorbing chamber can be prevented from being overheated, thermal degradation, damage, and other ill effects can be prevented, and thus the life of the microwave absorbent can be extended.

While the invention has been described by reference to specific embodiments chosen for the purposes of illustration, it should be apparent that numerous modifications could be made thereto, by those skilled in the art, without departing from the basic concept and scope of the invention.

1. Microwave continuous heating equipment: comprising a heating chamber, microwave absorbing chambers connected to the front and rear ends, respectively, of the heating chamber, and transport equipment for transporting workpieces thereon through the front-end microwave absorbing chamber, the heating chamber, and the rear-end microwave absorbing chamber in the order state;
wherein said microwave continuous heating equipment performs heat treatment by radiating microwave power onto the workpieces being transported through the heating chamber; and
wherein each of the microwave absorbing chambers includes a workpiece transport path having a meandering shape to prevent the microwave power from passing straight through openings at both ends of the microwave absorbing chambers.

2. Microwave continuous heating equipment according to claim 1, wherein the workpiece transport path in each of said microwave absorbing chambers has a shape meandering in a substantially L-shaped form, a crank-shaped form, a substantially U-shaped form, or a substantially S-shaped form.

3. Microwave continuous heating equipment according to claim 1, wherein each of the microwave absorbing chambers has a structure whose exterior side is covered with a metal cover, and whose interior side is covered with a microwave absorbing material having good microwave absorbance.

4. Microwave continuous heating equipment, according to claims 1, wherein metal shutters are installed at front and rear openings, respectively, of the heating chamber.

5. Microwave continuous heating equipment according to claims 1, wherein said heating equipment continuously heats ceramic moldings as workpieces.
